(19) United States
(12) Patent Application Publication
(10) Pub. No.: US 2026/0188255 A1
(43) Pub. Date: Jul. 2, 2026

(54) GATE DRIVER AND DISPLAY APPARATUS INCLUDING THE SAME

(71) Applicant: LG Display Co., Ltd., Seoul (KR)

(72) Inventors: Dong Ho CHOI, Paju-si (KR); Sung Hun KIM, Paju-si (KR)

(73) Assignee: LG Display Co., Ltd., Seoul (KR)

(21) Appl. No.: 19/431,181

(22) Filed: Dec. 23, 2025

(30) Foreign Application Priority Data
Dec. 31, 2024 (KR) 10-2024-0203032

(51) Int. Cl. G09G 3/3266; G09G 3/32

(52) U.S. Cl. CPC G09G 3/3266; G09G 3/32; G09G 2310/0245; G09G 2310/0267; G09G 2310/08; G09G 2330/021

(57) ABSTRACT

A display apparatus includes a display panel configured to display an image and a gate driver including a scan signal driver configured to apply at least one scan signal to the display panel and an emission control signal driver configured to apply an emission control signal to the display panel, wherein the emission control signal driver includes a signal generator configured to generate a carry signal and a signal controller configured to intactly output the carry signal as the emission control signal or vary an electric potential of the carry signal to output as the emission control signal, based on at least two control signals.

### CROSS-REFERENCE TO RELATED APPLICATIONS

This application claims the benefit of the Korean Patent Application No. 10-2024-0203032 filed on December 31, 2024, which is hereby incorporated by reference as if fully set forth herein.

### BACKGROUND

### Technical Field

The present disclosure relates to a gate driver and a display apparatus including the same.

### Description of the Related Art

As information technology advances, the market for display apparatuses which are connection mediums connecting a user with information is growing. Therefore, the use of display apparatuses such as light emitting display apparatuses, quantum dot display (QDD) apparatuses, and liquid crystal display (LCD) apparatuses is increasing.

The display apparatuses described above include a display panel which includes a plurality of subpixels, a driver which outputs a driving signal for driving the display panel, and a power supply which generates power which is to be supplied to the display panel or the driver.

In such display apparatuses, when the driving signal (for example, a scan signal and a data signal) is supplied to each of the subpixels provided in the display panel, a selected subpixel may transmit light or may self-emit light, and thus, an image may be displayed.

### BRIEF SUMMARY

The present disclosure provides a gate driver and a display apparatus including the same, which may output a signal for diversifying a region-based driving frequency to convert into a multi-frequency, when displaying at least two images on a display panel. Also, the present disclosure provides a gate driver and a display apparatus including the same, which may freely change an output waveform by using a relatively simple circuit and a signal, when diversifying a driving frequency for each display area. Also, the present disclosure provides a gate driver and a display apparatus including the same, which may easily and stably change refresh frame driving and frame skip driving, based on a relatively simple circuit and a signal.

As embodied and broadly described herein, a display apparatus includes a display panel configured to display an image and a gate driver including a scan signal driver configured to apply at least one scan signal to the display panel and an emission control signal driver configured to apply an emission control signal to the display panel, wherein the emission control signal driver includes a signal generator configured to generate a carry signal and a signal controller configured to intactly output the carry signal as the emission control signal or vary an electric potential of the carry signal to output as the emission control signal, based on at least two control signals.

The signal controller may be supplied with an electric potential of each of a first node and a second node of the signal generator as an input, and the signal controller may intactly output the carry signal as the emission control signal or may vary an electric potential of the carry signal to output as the emission control signal, based on the at least two control signals.

The signal controller may output the carry signal as a high voltage, based on a high voltage generated in a first node of the signal generator, or the signal controller may change the carry signal to a low voltage to output a changed carry signal, based on a low voltage applied to the signal controller in common.

The signal controller may include a first control transistor including a gate electrode connected to a first control signal input terminal to which a first control signal is applied and a first electrode connected to the second node, a second control transistor including a gate electrode connected to a Q2 node, a first electrode connected to a Q1 node, and a second electrode connected to a fourth node defined by a second electrode of the first control transistor, a third control transistor including a gate electrode connected to a second control signal input terminal to which a second control signal is applied, a first electrode connected to a high voltage line to which a high voltage is applied, and a second electrode connected to the Q2 node, a fourth control transistor including a gate electrode connected to the Q1 node and a first electrode connected to a third node defined by a low voltage line to which a low voltage is applied, a fifth control transistor including a gate electrode connected to a second electrode of the fourth control transistor, a first electrode connected to the first node, and a second electrode connected to an emission control signal output terminal, a sixth control transistor including a gate electrode connected to the Q1 node, a first electrode connected to a fifth node defined by the high voltage line, and a second electrode connected to a seventh node connected to the second electrode of the fourth control transistor and the gate electrode of the fifth control transistor, and a seventh control transistor including a gate electrode connected to the Q1 node, a first electrode connected to the third node, and a second electrode connected to the emission control signal output terminal.

The signal controller may include a first capacitor including a first electrode connected to the fourth node and a second electrode connected to the Q2 node and a second capacitor including a first electrode connected to the third node and a second electrode connected to the Q1 node.

The first control signal and the second control signal may be applied in opposite forms.

When the first control signal is applied as a high voltage, and the second control signal is applied as a low voltage, the signal controller may output the carry signal as a high voltage, and when the first control signal is applied as a low voltage, and the second control signal is applied as a high voltage, the signal controller may change the carry signal to a high voltage to output a changed carry signal.

In another aspect of the present disclosure, a gate driver includes a scan signal driver configured to output at least one scan signal and an emission control signal driver configured to apply an emission control signal, wherein the emission control signal driver includes a signal generator configured to generate a carry signal and a signal controller configured to intactly output the carry signal as the emission control signal or vary an electric potential of the carry signal to output as the emission control signal, based on at least two control signals.

The signal controller may be supplied with an electric potential of each of a first node and a second node of the signal generator as an input, and the signal controller may intactly output the carry signal as the emission control signal or may vary an electric potential of the carry signal to output as the emission control signal, based on the at least two control signals.

The signal controller may include a first control transistor including a gate electrode connected to a first control signal input terminal to which a first control signal is applied and a first electrode connected to the second node, a second control transistor including a gate electrode connected to a Q2 node, a first electrode connected to a Q1 node, and a second electrode connected to a fourth node defined by a second electrode of the first control transistor, a third control transistor including a gate electrode connected to a second control signal input terminal to which a second control signal is applied, a first electrode connected to a high voltage line to which a high voltage is applied, and a second electrode connected to the Q2 node, a fourth control transistor including a gate electrode connected to the Q1 node and a first electrode connected to a third node defined by a low voltage line to which a low voltage is applied, a fifth control transistor including a gate electrode connected to a second electrode of the fourth control transistor, a first electrode connected to the first node, and a second electrode connected to an emission control signal output terminal, a sixth control transistor including a gate electrode connected to the Q1 node, a first electrode connected to a fifth node defined by the high voltage line, and a second electrode connected to a seventh node connected to the second electrode of the fourth control transistor and the gate electrode of the fifth control transistor, and a seventh control transistor including a gate electrode connected to the Q1 node, a first electrode connected to the third node, and a second electrode connected to the emission control signal output terminal.

The present disclosure provides a gate driver and a display apparatus including the same, which may output a signal for diversifying a region-based driving frequency to convert into a multi-frequency, when displaying at least two images on a display panel. Also, the present disclosure provides a gate driver and a display apparatus including the same, which may freely change an output waveform by using a relatively simple circuit and a signal, when diversifying a driving frequency for each display area. Also, the present disclosure provides a gate driver and a display apparatus including the same, which may easily and stably change refresh frame driving and frame skip driving, based on a relatively simple circuit and a signal.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a light emitting display apparatus, and

FIG. 2 is a diagram for describing a gate driver;

FIG. 3 is an exemplary diagram illustrating a circuit configuration of a subpixel according to an embodiment,

FIG. 4 is a waveform diagram for performing normal driving of the subpixel illustrated in FIG. 3,

FIG. 5 is a waveform diagram for performing frame skip driving of the subpixel illustrated in FIG. 3,

FIG. 6 is an exemplary diagram of a display panel including the subpixel illustrated in FIG. 3 and a gate driver for driving the display panel, and

FIG. 7 is a diagram for describing a driving characteristic of the display panel implemented based on the subpixel of FIG. 3;

FIG. 8 is an exemplary diagram illustrating a region-based driving frequency when a display panel according to an embodiment displays two images, and

FIG. 9 is an exemplary diagram illustrating a region-based driving frequency when a display panel according to an embodiment displays four images;

FIG. 10 is a stage configuration diagram of an emission control signal driver according to an embodiment,

FIG. 11 is an exemplary diagram illustrating a circuit configuration of a first emission control signal driver illustrated in FIG. 10,

FIG. 12 is an exemplary diagram illustrating a driving waveform of a first signal generator, and

FIGS. 13 to 18 are exemplary diagrams illustrating a period-based operation of the first signal generator illustrated in FIG. 11;

FIG. 19 is a waveform diagram illustrating a first control signal and a second control signal applied during a first period,

FIG. 20 is a state diagram illustrating an operation performed by a first signal controller during the first period, and

FIG. 21 is a waveform diagram illustrating a node voltage and an output of the first signal controller during the first period;

FIG. 22 is a waveform diagram illustrating a first control signal and a second control signal applied during a second period,

FIG. 23 is a state diagram illustrating an operation performed by a first signal controller during the second period, and

FIG. 24 is a waveform diagram illustrating a node voltage and an output of the first signal controller during the second period;

FIG. 25 is an output waveform diagram of carry signals output from signal generators of FIG. 10, and

FIG. 26 is an output waveform diagram of emission control signals output from signal controllers of FIG. 10; and

FIG. 27 is a waveform diagram illustrating a portion where a first control signal and a second control signal maintain a high voltage, and

FIGS. 28 and 29 are state diagrams illustrating an operation performed by a first signal controller, based on a waveform illustrated in FIG. 27.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Reference will now be made in detail to embodiments of the present disclosure, examples of which may be illustrated in the accompanying drawings. In the following description, when a detailed description of well-known functions or configurations related to this document is determined to unnecessarily obscure a gist of the inventive concept, the detailed description thereof will be omitted or may be briefly provided. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

The aforementioned objectives, features, and advantages of the present disclosure will be described in detail with reference to the accompanying drawings, enabling those skilled in the art to easily implement the technical idea of the disclosure. Detailed descriptions of well-known technologies related to the disclosure will be omitted or may be briefly provided, if they unnecessarily obscure its essence. Hereinafter, embodiments of the present disclosure will be described in detail with reference to the accompanying drawings. Identical reference numerals in the drawings are used to refer to identical or similar components.

Although terms such as 'first,' 'second,' and the like are used to describe various components, these components are not limited by these terms. These terms are merely used to distinguish one component from another, and unless explicitly stated otherwise, the first component may be the second component, and vice versa.

Throughout the specification, unless explicitly stated otherwise, each component may be singular or plural. Throughout the drawings and the detailed description, unless otherwise described, the same drawing reference numerals should be understood to refer to the same elements, features, and structures. The relative size and depiction of these elements may be exaggerated for clarity, illustration, and convenience.

The singular expressions used in this specification include the plural expression unless the context clearly indicates otherwise. In this application, terms such as 'comprising' or 'including' should not be interpreted as necessarily including all the components or steps listed in the specification; some components or steps may be excluded, or additional components or steps may be included.

Throughout the specification, the term 'A and/or B' means A, B, or both A and B, unless otherwise stated, and the term 'C to D' means C or more and D or less, unless otherwise stated.

Any implementation described herein as an “example” is not necessarily to be construed as preferred or advantageous over other implementations.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

In the description of the various embodiments of the present disclosure, where positional relationships are described, for example, when a position relation between two parts is described as, for example, “on,” “over,” “under,” and “next,” or the like, one or more other parts may be located between the two parts unless a more limiting term, such as “just” or “direct(ly)” is used. For example, where an element or layer is disposed “on” another element or layer, a third element or layer may be interposed therebetween.

In describing a temporal relationship, when the temporal order is described as, for example, “after,” “subsequent,” “next,” and “before,” a case that is not continuous may be included unless a more limiting term, such as “just,” “immediate(ly),” or “direct(ly)” is used.

Also, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

It will be apparent to those skilled in the art that various modifications and variations can be made to the embodiments of the present disclosure without departing from the technical idea or scope of the present disclosure. Thus, it is intended that the present disclosure covers the modifications and variations of this disclosure provided they come within the scope of the appended claims and their equivalents.

A display apparatus according to the present disclosure may be applied to televisions (TVs), video players, personal computers (PCs), home theaters, electronic devices for vehicles, and smartphones, but is not limited thereto. The display apparatus according to the present disclosure may be implemented as a light emitting display apparatus, a quantum dot display (QDD) apparatus, or a liquid crystal display (LCD) apparatus. Hereinafter, for convenience of description, a light emitting display apparatus self-emitting light by using an inorganic light emitting diode or an organic light emitting diode will be described for example.

Moreover, a transistor described below may be implemented with an n-type transistor, a p-type transistor, or a combination of an n-type transistor and a p-type transistor. A transistor may be a three-electrode element including a gate, a source, and a drain. The source may be an electrode which provides a carrier to a transistor. In the transistor, a carrier may start to flow from the source. The drain may be an electrode where the carrier flows from the transistor to the outside. That is, in the transistor, the carrier flows from the source to the drain.

In the p-type transistor, because a carrier is a hole, a source voltage may be higher than a drain voltage so that the hole flows from the source to the drain. In the p-type transistor, because the hole flows from the source to the drain, a current may flow from the source to the drain. On the other hand, in the n-type transistor, because a carrier is an electron, a source voltage may be lower than a drain voltage so that the electron flows from the source to the drain. In the n-type transistor, because the electron flows from the drain to the source, a current may flow from the drain to the source. However, a source and a drain of a transistor may switch therebetween based on a voltage applied thereto. Based thereon, in the following description, one of a source and a drain will be described as a first electrode, and the other of the source and the drain will be described as a second electrode.

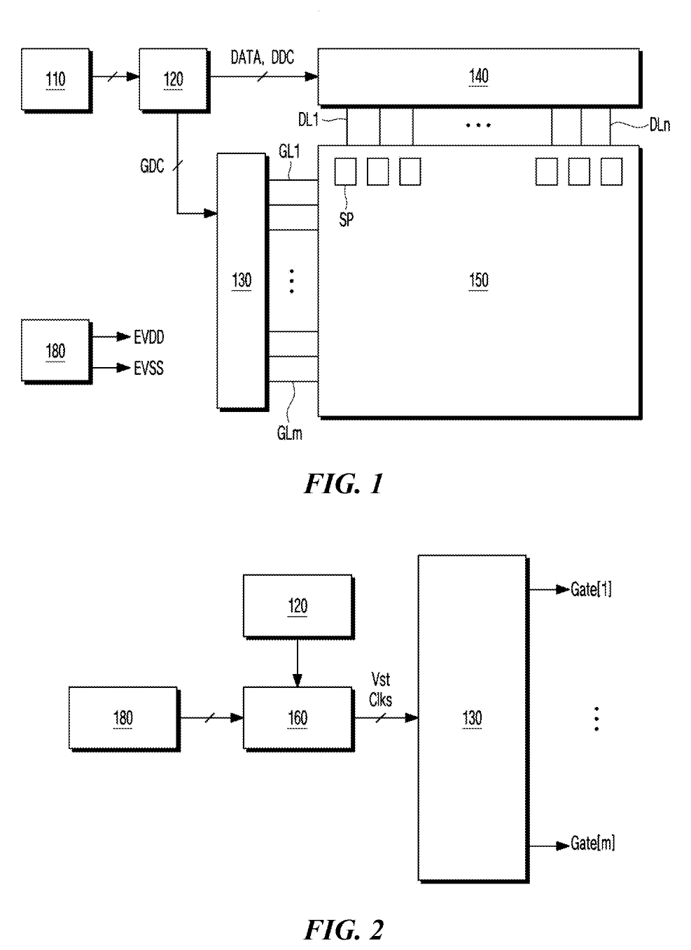

FIG. 1 is a block diagram schematically illustrating a light emitting display apparatus, and FIG. 2 is a diagram for describing a gate driver.

As illustrated in FIGS. 1 and 2, a light emitting display apparatus according to an embodiment of the present disclosure may include a timing controller 120, a gate driver 130, a data driver 140, a display panel 150, and a power supply 180.

A video supply unit 110 (a set or a host system) may output a video data signal supplied from the outside or an image data signal stored in an internal memory thereof. The video supply unit 110 may supply a data signal and the various driving signals to the timing controller 120.

The timing controller 120 may output a gate timing control signal GDC for controlling an operation timing of the gate driver 130, a data timing control signal DDC for controlling an operation timing of the data driver 140, and various synchronization signals (a vertical synchronization signal Vsync and a horizontal synchronization signal Hsync). The timing controller 120 may provide the data driver 140 with the data timing control signal DDC and a data signal DATA supplied from the video supply unit 110. The timing controller 120 may be implemented as an integrated circuit (IC) type and may be mounted on a printed circuit board (PCB), but is not limited thereto.

The gate driver 130 may output a gate signal (or a gate voltage) in response to the gate timing control signal GDC supplied from the timing controller 120. The gate driver 130 may output gate signals Gate[1] to Gate[m] through gate lines GL1 to GLm connected to subpixels of the display panel 150. The gate driver 130 may be controlled by the timing controller 120, the power supply 180, and the level shifter 160. The level shifter 160 may generate signals Vst and Clks needed for driving of the gate driver 130, based on signals and voltages output from the timing controller 120 and the power supply 180. The gate driver 130 may be implemented as an IC type or may be directly provided on the display panel 150 in a gate in panel (GIP) type, but is not limited thereto.

In response to the data timing control signal DDC supplied from the timing controller 120, the data driver 140 may sample and latch the data signal DATA, convert a digital data signal into an analog data voltage, based on a gamma reference voltage, and output the analog data voltage.

The data driver 140 may respectively supply data voltages to the subpixels of the display panel 150 through a plurality of data lines DL1 to DLn. The data driver 140 may be implemented as an IC type or may be mounted on the display panel 150 or a PCB, but is not limited thereto.

The power supply 180 may generate a high-level voltage and a low-level voltage, based on an external input voltage supplied from the outside, and may output the high-level voltage and the low-level voltage through a high-level voltage line EVDD and a low-level voltage line EVSS. The power supply 180 may generate and output a voltage needed for driving of the gate driver 130 or a voltage needed for driving of the data driver 140, in addition to the high-level voltage and the low-level voltage.

The display panel 150 may be manufactured based on a substrate, having stiffness or flexibility, such as glass, silicone, or polyimide. The display panel 150 may include a plurality of subpixels SP for displaying an image. The subpixel SP may self-emit light toward an upper surface or the upper substrate and a lower substrate of the display panel 150. The subpixel SP may emit light having one color of red, green, blue, and white. The display panel 150 may display an image, based on a pixel configured with a red subpixel, a green subpixel, and a blue subpixel or a pixel configured with a red subpixel, a green subpixel, a blue subpixel, and a white subpixel.

In the above description, each of the timing controller 120, the gate driver 130, and the data driver 140 has been described as an individual element. However, based on an implementation type of the light emitting display apparatus, one or more of the timing controller 120, the gate driver 130, and the data driver 140 may be integrated into one IC.

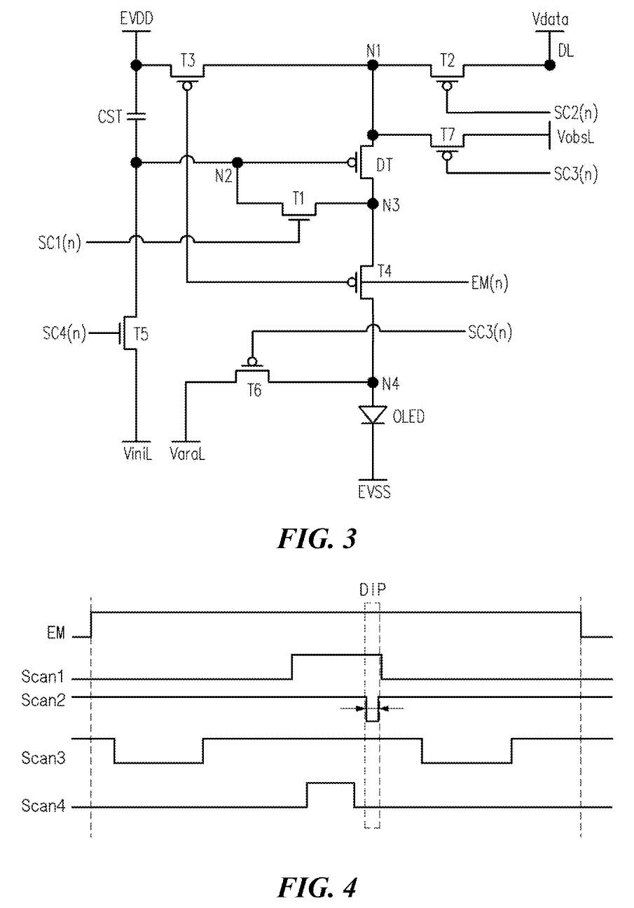

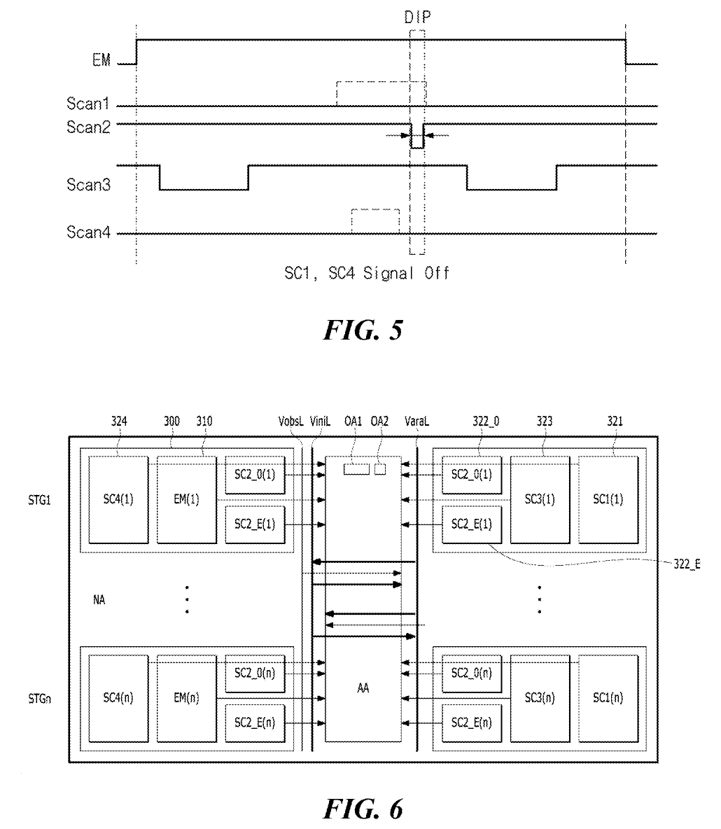

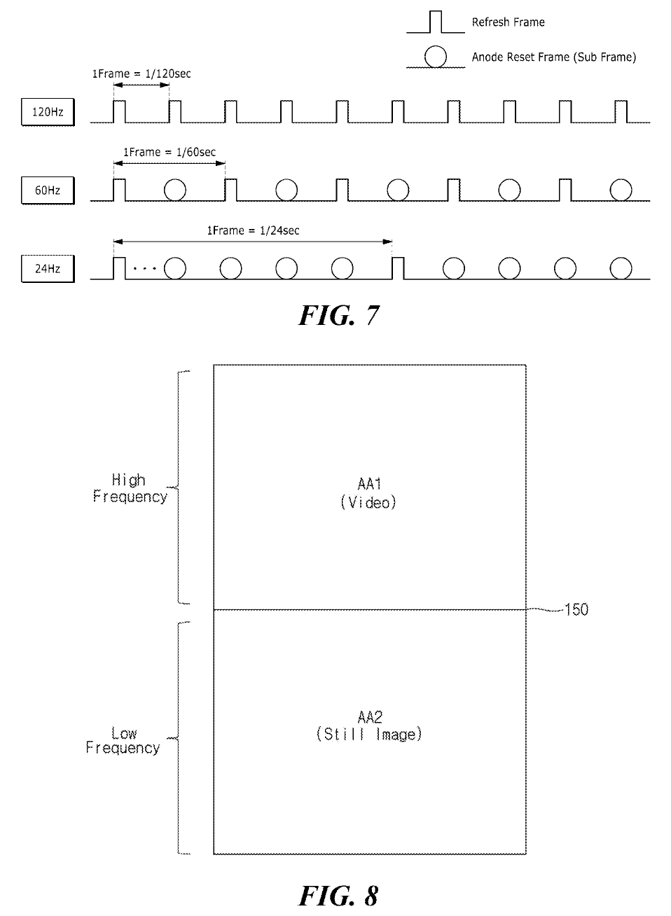

FIG. 3 is an exemplary diagram illustrating a circuit configuration of a subpixel according to an embodiment, FIG. 4 is a waveform diagram for performing normal driving of the subpixel illustrated in FIG. 3, FIG. 5 is a waveform diagram for performing frame skip driving of the subpixel illustrated in FIG. 3, FIG. 6 is an exemplary diagram of a display panel including the subpixel illustrated in FIG. 3 and a gate driver for driving the display panel, and FIG. 7 is a diagram for describing a driving characteristic of the display panel implemented based on the subpixel of FIG. 3.

As illustrated in FIG. 3, an N^{th} subpixel may include a first transistor T1, a second transistor T2, a third transistor T3, a fourth transistor T4, a fifth transistor T5, a sixth transistor T6, a seventh transistor T7, a driving transistor DT, a capacitor CST, and a light emitting device OLED.

In FIG. 3, for example, the first transistor T1 and the fifth transistor T5 may be implemented as an n type based on an oxide semiconductor, and the second transistor T2, the third transistor T3, the fourth transistor T4, the sixth transistor T6, the seventh transistor T7, and the driving transistor DT may be implemented as a p type based on a polycrystalline semiconductor, but the embodiments of the present disclosure are not limited thereto.

The first transistor T1 may include a gate electrode connected to a first scan line SC1(n), a first electrode connected to a second node N2, and a second electrode connected to a third node N3. The first transistor T1 may be turned on in response to a first scan signal applied through the first scan line SC1(n). When the first transistor T1 is turned on, a threshold voltage of the driving transistor DT may be sampled.

The second transistor T2 may include a gate electrode connected to a second scan line SC2(n), a first electrode connected to a data line DL, and a second electrode connected to a first node N1. The second transistor T2 may be turned on in response to a second scan signal applied through the second scan line SC2(n). When the second transistor T2 is turned on, a data voltage Vdata applied through the data line DL may be transferred to the first node N1.

The third transistor T3 may include a gate electrode connected to an emission control signal line EM(n), a first electrode connected to the high-level voltage line EVDD, and a second electrode connected to the first node N1. The third transistor T3 may be turned on in response to an emission control signal applied through the emission control signal line EM(n). When the third transistor T3 is turned on, a high-level voltage applied through the high-level voltage line EVDD may be transferred to the first node N1.

The fourth transistor T4 may include a gate electrode connected to the emission control signal line EM(n), a first electrode connected to the third node N3, and a second electrode connected to an anode electrode of the light emitting device OLED. The fourth transistor T4 may be turned on in response to the emission control signal applied through the emission control signal line EM(n). When the fourth transistor T4 is turned on, a driving current generated from the driving transistor DT may be transferred to the light emitting device OLED. When the fourth transistor T4 is turned on, the light emitting device OLED may emit light, based on the driving current generated from the driving transistor DT.

The fifth transistor T5 may include a gate electrode connected to a fourth scan line SC4(n), a first electrode connected to a first initialization voltage line ViniL, and a second electrode connected to the second node N2. The fifth transistor T5 may be turned on in response to a fourth scan signal applied through the fourth scan line SC4(n). When the fifth transistor T5 is turned on, a first initialization voltage applied through the first initialization voltage line ViniL may be transferred to the second node N2. When the fifth transistor T5 is turned on, an electric charge remaining in a second electrode of the capacitor CST and a gate electrode of the driving transistor DT connected to the second node N2 may be initialized.

The sixth transistor T6 may include a gate electrode connected to a third scan line SC3(n), a first electrode connected to a second initialization voltage line VaraL, and a second electrode connected to the anode electrode of the light emitting device OLED. The sixth transistor T6 may be turned on in response to a third scan signal applied through the third scan line SC3(n). When the sixth transistor T6 is turned on, a second initialization voltage applied through the second initialization voltage line VaraL may be transferred to the anode electrode of the light emitting device OLED. When the sixth transistor T6 is turned on, an electric charge remaining in the anode electrode of the light emitting device OLED may be initialized.

The seventh transistor T7 may include a gate electrode connected to a third scan line SC3(n), a first electrode connected to a bias voltage line VobsL, and a second electrode connected to the first node N1. The seventh transistor T7 may be turned on in response to a third scan signal applied through the third scan line SC3(n). When the seventh transistor T7 is turned on, a bias voltage applied through the bias voltage line VobsL may be transferred to the first node N1. When the seventh transistor T7 is turned on, the driving transistor DT connected to the first node N1 may maintain a stronger saturation state, based on the bias voltage. Accordingly, a phenomenon may be improved where a voltage charge time for charging of a voltage applied to the anode electrode of the light emitting device OLED during an emission period is reduced or delayed.

For example, as a level of the bias voltage increases, a voltage of the third node N3 which is a drain electrode of the driving transistor DT may increase, and a gate-source voltage or a drain-source voltage of the driving transistor DT may be reduced. In some implementations, a level of the bias voltage is higher than that of the data voltage Vdata. Under such a condition, a magnitude of a drain-source current Id passing through the driving transistor DT may decrease, and a stress of the driving transistor DT may be reduced, thereby reducing or preventing a charge delay of the third node N3. In other words, when an on bias stress operation is performed before sampling the threshold voltage of the driving transistor DT, a hysteresis of the driving transistor DT may be alleviated.

The driving transistor DT may include the gate electrode connected to the second node N2, a first electrode connected to the first node N1, and a second electrode connected to the third node N3. The driving transistor DT may be driven based on the data voltage Vdata stored in the capacitor CST to generate the driving current.

The capacitor CST may include a first electrode connected to the high-level voltage line EVDD and a second electrode connected to the second node N2. The capacitor CST may store the data voltage Vdata for a certain time, and then, may transfer the data voltage Vdata to the gate electrode of the driving transistor DT.

The light emitting device OLED may include the anode electrode connected to the second electrode of the fourth transistor T4 and a cathode electrode connected to the low-level voltage line EVSS. The light emitting device OLED may emit light, based on the driving current transferred through the turned-on fourth transistor T4.

The subpixel illustrated in FIG. 3 may perform normal driving (a refresh frame mode), based on a waveform illustrated in FIG. 4. The normal driving may be a driving mode which applies a new data voltage to the subpixel during a data write period DIP and displays a new image, based on the new data voltage.

For normal driving, the emission control signal EM, the first scan signal Scan1, and the third scan signal Scan3 may be applied as a high voltage, and the second scan signal Scan2 and the fourth scan signal Scan4 may be applied as a low voltage. In normal driving, the subpixel of FIG. 3 may perform a programming operation which samples the threshold voltage of the driving transistor DT, based on the turned-on first transistor T1, and stores a data voltage applied through the turned-on second transistor T2.

Moreover, the subpixel illustrated in FIG. 3 may perform frame skip driving (a frame skip mode), based on a waveform illustrated in FIG. 5. The frame skip driving may be a driving mode which does not apply a data voltage to the subpixel during the data write period DIP and maintains a previous image, based on a previously applied data voltage.

For frame skip driving, the emission control signal EM and the third scan signal Scan3 may be applied as a high voltage, and the first scan signal Scan1, the second scan signal Scan2, and the fourth scan signal Scan4 may be applied as a low voltage. In frame skip driving, the subpixel of FIG. 3 may perform a maintenance operation which maintains a voltage of the second node N2 under the same or substantially same condition as a previous condition without receiving a new data voltage despite the first transistor T1 being turned on.

As illustrated in FIGS. 4 and 5, the first scan signal Scan1, the second scan signal Scan2, the third scan signal Scan3, and the fourth scan signal Scan4 may vary in form of a pulse, based on a driving mode. On the other hand, the emission control signal EM may not vary in form of a pulse, based on the driving mode. However, driving waveforms of FIGS. 4 and 5 may be merely an embodiment, but are not limited thereto.

In a case where a display panel is implemented based on the subpixel illustrated in FIG. 3, as in FIG. 6, the gate driver may include a shift register 300 which is disposed in each of a left non-display area NA and a right non-display area NA with respect to a display area AA.

The shift register 300 may include an emission control signal driver 310 and a plurality of scan signal drivers 321 to 324. The scan signal drivers 321 to 324 may include a first scan signal driver 321, a second scan signal driver 322_O and 322_E, a third scan signal driver 323, and a fourth scan signal driver 324. Here, an example is illustrated where the second scan signal driver 322_O and 322_E is divided into an odd-numbered second scan signal driver 322_O which outputs an odd-numbered first scan signal to an odd-numbered subpixel and an even-numbered second scan signal driver 322_E which outputs an even-numbered first scan signal to an even-numbered subpixel, but embodiments of the present disclosure are not limited thereto.

The shift register 300 may be configured with a plurality of stages STG1 to STGn which are dependently connected to each other. The stages STG1 to STGn may include first scan signal generators SC1(1) to SC1(n), second scan signal generators SC2_O(1) to SC2_O(n) and SC2_E(1) to SC2_E(n), third scan signal generators SC3(1) to SC3(n), fourth scan signal generators SC4(1) to SC4(n), and emission control signal generators EM(1) to EM(n).

Hereinafter, a portion corresponding to one gate line will be described based on the N^{th} subpixel of FIG. 3 and an N^{th} stage STGn of FIG. 6. In the following descriptions, for convenience of description, the term “N^{th}” may be omitted.

The first scan signal generator SC1(n) may output a first scan signal through a first scan line SC1(n) of a subpixel. The second scan signal generator SC2(n) may output a second scan signal through a second scan line SC2(n) of the subpixel. The third scan signal generator SC3(n) may output a third scan signal through a third scan line SC3(n) of the subpixel. The fourth scan signal generator SC4(n) may output a fourth scan signal through a fourth scan line SC4(n) of the subpixel. The emission control signal generator EM(n) may output an emission control signal through the emission control signal line EM(n) of the subpixel.

In FIG. 6, an example is illustrated where the second scan signal generators SC2_O(1) to SC2_O(n) and SC2_E(1) to SC2_E(n) are disposed in the left non-display area NA and the right non-display area NA with respect to the display area AA, the fourth scan signal generators SC4(1) to SC4(n) and the emission control signal generators EM(1) to EM(n) are disposed in the left non-display area NA, and the first scan signal generators SC1(1) to SC1(n) and the third scan signal generators SC3(1) to SC3(n) are disposed in the right non-display area NA, but this may be merely an embodiment and embodiments of the present disclosure are not limited thereto. Also, in FIG. 6, an example is illustrated where the bias voltage line VobsL, the first initialization voltage line ViniL, and the second initialization voltage line VaraL are disposed between the shift register 300 and the display area AA, but this may be merely an embodiment and embodiments of the present disclosure are not limited thereto. Also, in FIG. 6, an example is illustrated where optical regions OA1 and OA2 such as a photographing device such as a camera (an image sensor) and sensors such as a proximity sensor and an illumination sensor are disposed in an upper portion of the display area AA, but this may be merely an embodiment and embodiments of the present disclosure are not limited thereto.

As illustrate in FIGS. 1 and 7, the display panel 150 may operate in a variable refresh rate (VRR) mode. The VRR mode may be a driving mode where the display panel 150 is driven at a certain driving frequency, and then, increases or decreases a refresh rate needed for updating of a data voltage according to a high-speed driving or low-speed driving condition and reduces power consumption. For example, the display panel 150 may drive one frame at 120 Hz (1Frame = 1/120sec), or may drive one frame at 60 Hz (1Frame = 1/60sec), or may diversify a driving speed for driving one frame at 24 Hz (1Frame = 1/24sec).

Under a high-speed driving condition such as 120 Hz, a refresh frame for refreshing (image refresh) a data voltage at every frame may be provided. On the other hand, under a low-speed driving condition such as 60 Hz or 24 Hz, an anode reset frame for refreshing a data voltage at every N frames (where N may be an integer of 1 or more) may be provided between anode reset frames. For example, the normal driving mode of FIG. 4 may include the refresh frame, and the frame skip driving mode of FIG. 5 may include the anode reset frame.

The anode reset frame may be included in a sub-frame, and a device may operate in a corresponding frame to enable the display panel 150 to normally display an image. Also, the anode reset frame may be performed under the low-speed driving condition. Therefore, the anode reset frame may correspond to a level where there is hardly a motion of an image, or a still image is displayed, and thus, may be defined as that only an output of a scan signal is performed in a state where an output of a data voltage stops, but embodiments of the present disclosure are not limited thereto.

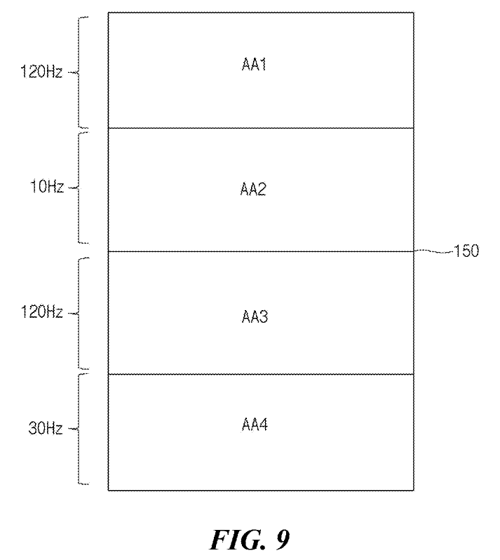

FIG. 8 is an exemplary diagram illustrating a region-based driving frequency when a display panel according to an embodiment displays two images, and FIG. 9 is an exemplary diagram illustrating a region-based driving frequency when a display panel according to an embodiment displays four images.

As illustrated in FIGS. 8 and 9, a display panel 150 according to an embodiment may display at least two different images on a display area, based on the subpixel described above and a gate driver for driving the subpixel and may diversify a driving frequency thereof to convert into a multi-frequency. This will be described below for example.

As in a first embodiment of FIG. 8, a video may be displayed on a first display area AA1 of the display panel 150, and a still image may be displayed on a second display area AA2 of the display panel 150. In this case, in an embodiment, the first display area AA1 may be driven at a high frequency which is higher than that of the second display area AA2, and the second display area AA2 may be driven at a low frequency which is lower than that of the first display area AA1.

As in a second embodiment of FIG. 9, the same or substantially same image may be displayed on the first display area AA1 and a third display area AA3 of the display panel 150, and different images may be respectively displayed on the second display area AA2 and a fourth display area AA4 of the display panel 150. In this case, in an embodiment, the first display area AA1 and the third display area AA3 may be driven at 120 Hz, the fourth display area AA4 may be driven at 30 Hz, and the second display area AA2 may be driven at 10 Hz.

As described above, in a case where the display area of the display panel 150 is divided into at least two areas and may be divisionally driven at various driving frequencies, frame skip driving requiring no application of a data voltage may be more easily performed than normal driving requiring application of a data voltage. An embodiment may propose the following emission control signal driver for diversifying a driving frequency in frame skip driving.

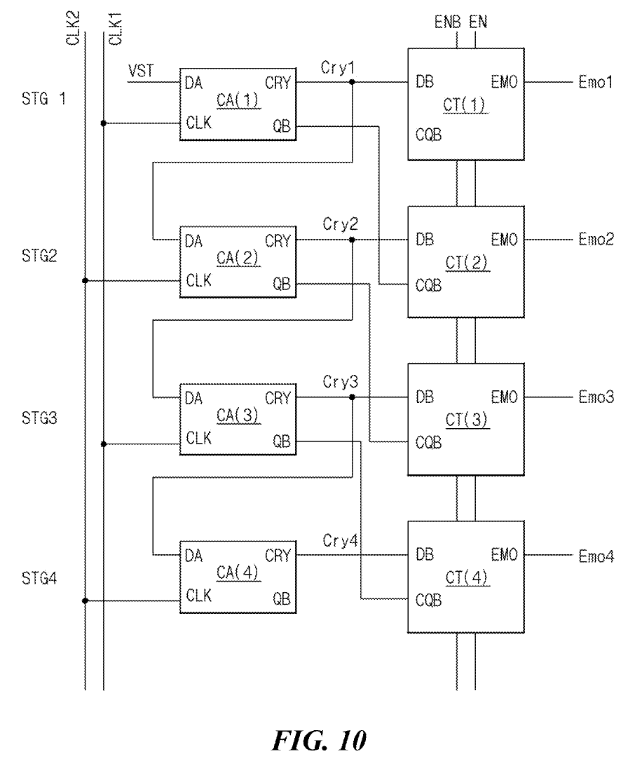

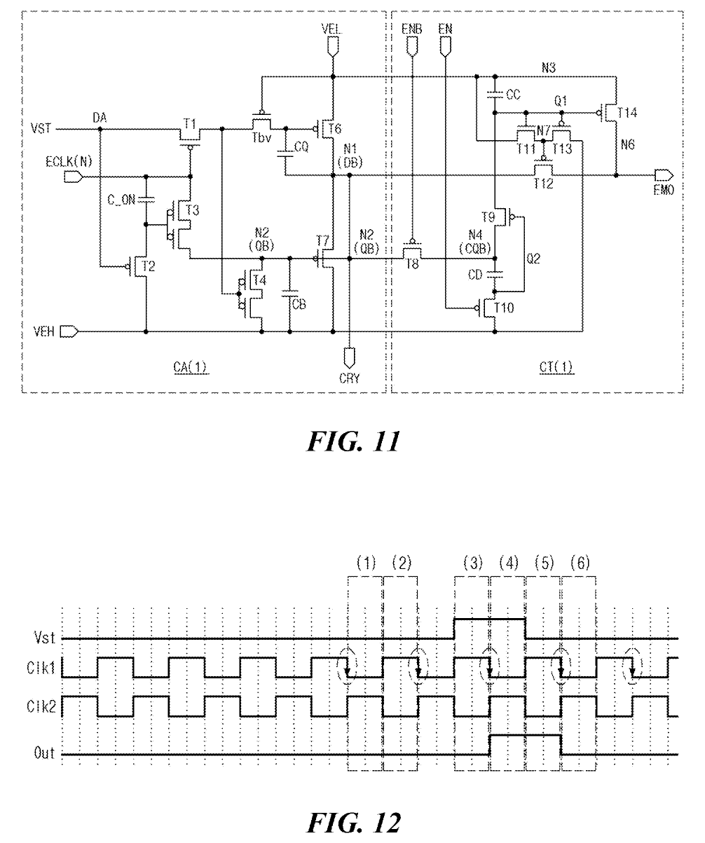

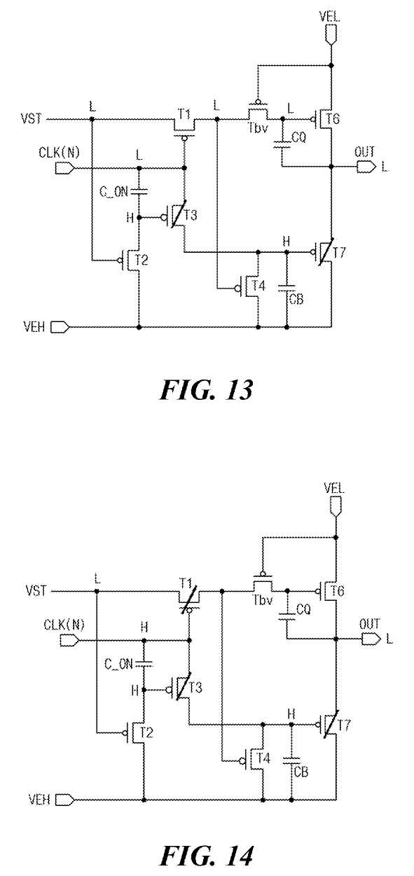

FIG. 10 is a stage configuration diagram of an emission control signal driver according to an embodiment, FIG. 11 is an exemplary diagram illustrating a circuit configuration of a first emission control signal driver illustrated in FIG. 10, FIG. 12 is an exemplary diagram illustrating a driving waveform of a first signal generator, and FIGS. 13 to 18 are exemplary diagrams illustrating a period-based operation of the first signal generator illustrated in FIG. 11.

As illustrated in FIG. 10, an emission control signal driver CA and CT may include a plurality of signal generators CA(1) to CA(4) which generate carry signals Cry1 to Cry4 and a plurality of signal controllers CT(1) to CT(4) which output emission control signals Emo1 to Emo4. The signal generators CA(1) to CA(4) may output the emission control signals Emo1 to Emo4, and thus, may be disposed closer to a display area than the signal generators CA(1) to CA(4).

Each of the signal generators CA(1) to CA(4) may include a start signal input terminal DA which receives a start signal or a carry signal of a signal generator included in a front-end stage, a clock signal input terminal CLK which receives a clock signal, a carry signal output terminal CRY which outputs the carry signal, and a node voltage output terminal QB which outputs a node voltage of the signal generator. Each of the signal controllers CT(1) to CT(4) may include a carry signal input terminal DB which receives a carry signal of a signal generator included in the same stage, a node voltage input terminal CQB which receives a node voltage of a signal generator included in a front-end stage, a first control signal input terminal ENB which receives a first control signal, a second control signal input terminal EN which receives a second control signal, and an emission control signal output terminal EMO which outputs an emission control signal.

A connection relationship between a first signal generator CA(1) and a first signal controller CT(1) will be described below with respect to a first stage STG1.

A start signal input terminal DA of the first signal generator CA(1) may be connected to a start signal line VST to which a start signal is applied. A clock signal input terminal CLK of the first signal generator CA(1) may be connected to a first clock signal line CLK1 to which a first clock signal is applied.

A carry signal input terminal DB of the first signal controller CT(1) may be connected to a carry signal output terminal CRY of the first signal generator CA(1) included in the first stage STG1. A node voltage input terminal CQB of the first signal controller CT(1) may be connected to a node voltage output terminal of a first signal generator included in a dummy stage (not shown).

Hereinafter, a circuit configuration of each of the first signal generator CA(1) and the first signal controller CT(1) will be described with respect to the first stage STG1.

As illustrated in FIGS. 10 and 11, the first signal generator CA(1) may include a first signal transistor T1, a second signal transistor T2, a third signal transistor T3, a fourth signal transistor T4, a fifth signal transistor Tbv, a sixth signal transistor T6, a seventh signal transistor T7, a signal capacitor C_ON, a first output capacitor CQ, and a second output capacitor CB.

The first signal transistor T1 may include a gate electrode connected to a clock signal line CLK(N), a first electrode connected to a start signal input terminal DA (or a start signal line VST), and a second electrode connected to a first electrode of the fifth signal transistor Tbv. The first signal transistor T1 may be turned on based on a clock signal applied through the clock signal line CLK(N) and may transfer a start signal (or a carry signal of a front-end stage), applied through the start signal line VST, to the first electrode of the fifth signal transistor Tbv.

The second signal transistor T2 may include a gate electrode connected to a start signal input terminal DA (or the start signal line VST), a first electrode connected to a high voltage line VEH, and a second electrode connected to a gate electrode of the third signal transistor T3. The second signal transistor T2 may be turned on based on a start signal (or a carry signal of a front-end stage) applied through the start signal line VST and may transfer a high voltage, applied through the high voltage line VEH, to the gate electrode of the third signal transistor T3.

The third signal transistor T3 may include a gate electrode connected to the second electrode of the second signal transistor T2 and a second electrode of the signal capacitor C_ON, a first electrode connected to the clock signal line CLK(N), and a second electrode connected to the second node N2 (or a QB node QB). The third signal transistor T3 may be turned on based on the clock signal applied through the clock signal line CLK(N) and may transfer the clock signal to the second node N2.

The signal capacitor C_ON may include a first electrode connected to the clock signal line CLK(N) and the second electrode connected to the gate electrode of the third signal transistor T3. The signal capacitor C_ON may allow an electric potential applied to the gate electrode of the third signal transistor T3 to be stably maintained without being floated.

The fourth signal transistor T4 may include a gate electrode connected to the second electrode of the first signal transistor T1, a first electrode connected to a high voltage line VEH, and a second electrode connected to the second node N2 (or the QB node QB). The fourth signal transistor T4 may be turned on based on the start signal transferred through the first signal transistor T1 and may transfer a high voltage, applied through the high voltage line VEH, to the second node N2.

The fifth signal transistor Tbv may include a gate electrode connected to a low voltage line VEL, a first electrode connected to the second electrode of the first signal transistor T1, and a second electrode connected to a gate electrode of the sixth signal transistor T6. The fifth signal transistor Tbv may be turned on based on a low voltage applied through the low voltage line VEL and may transfer the start signal (or a carry signal of a front-end stage), transferred through the first signal transistor T1, to the gate electrode of the sixth signal transistor T6. The fifth signal transistor Tbv may allow an electric potential of a first electrode node and an electric potential of a second electrode node to be stably maintained.

The sixth signal transistor T6 may include the gate electrode connected to the second electrode of the fifth signal transistor Tbv, a first electrode connected to the low voltage line VEL, and a second electrode connected to the first node N1 and a carry signal output terminal CRY. The sixth signal transistor T6 may be turned on the start signal transferred through the fifth signal transistor Tbv and may output a first carry signal Cry1 of a low voltage, based on a low voltage applied through the low voltage line VEL. The sixth signal transistor T6 may output the first carry signal Cry1 of a low voltage through the carry signal output terminal CRY, and thus, may be defined as a low voltage carry signal output transistor.

The first output capacitor CQ may include a first electrode connected to the gate electrode of the sixth signal transistor T6 and a second electrode connected to the first node N1 or the carry signal output terminal CRY. The first output capacitor CQ may allow a first carry signal to be stably output through the carry signal output terminal CRY.

The seventh signal transistor T7 may include a gate electrode connected to the second electrode of the third signal transistor T3, a first electrode connected to the high voltage line VEH, and a second electrode connected to the first node N1 and the carry signal output terminal CRY. The seventh signal transistor T7 may be turned on based on the clock signal transferred through the third signal transistor T3 and may output the first carry signal Cry1 of a high voltage, based on a high voltage applied through the high voltage line VEH. The seventh signal transistor T7 may output the first carry signal Cry1 of a high voltage through the carry signal output terminal CRY, and thus, may be defined as a high voltage carry signal output transistor.

The second output capacitor CB may include a first electrode connected to the gate electrode of the seventh signal transistor T7 and a second electrode connected to the high voltage line VEH. The second output capacitor CB may allow an electric potential of the second node N2 to be maintained in an electrically stabilized state without being floated.

The signal controller CT(1) may include a first control transistor T8, a second control transistor T9, a third control transistor T10, a fourth control transistor T11, a fifth control transistor T12, a sixth control transistor T13, a seventh control transistor T14, a first capacitor CD, and a second capacitor CC.

The first control transistor T8 may include a gate electrode connected to a first control signal input terminal ENB, a first electrode connected to the second node N2 (or the QB node QB), and a second electrode connected to a fourth node N4 (or a CQB node CQB). The first control transistor T8 may be turned on based on a first control signal applied through the first control signal input terminal ENB and may transfer an electric potential of the second node N2 to the fourth node N4.

The second control transistor T9 may include a gate electrode connected to a Q2 node Q2, a first electrode connected to a Q1 node Q1, and a second electrode connected to the fourth node N4 (or the CQB node CQB). The second control transistor T9 may be turned on based on an electric potential of the Q2 node Q2 and may transfer an electric potential of the Q1 node Q1 to the fourth node N4.

The third control transistor T10 may include a gate electrode connected to a second control signal input terminal EN, a first electrode connected to the high voltage line VEH, and a second electrode connected to the Q2 node Q2. The third control transistor T10 may be turned on based on a second control signal applied through the second control signal input terminal EN and may transfer a high voltage, applied through the high voltage line VEH, to the Q2 node Q2.

The first capacitor CD may include a first electrode connected to the fourth node N4 (or the CQB node CQB) and a second electrode connected to the second electrode of the third control transistor T10 and the Q2 node Q2. The first capacitor CD may allow an electric potential of the fourth node N4 to be stably maintained.

The fourth control transistor T11 may include a gate electrode connected to the Q1 node Q1, a first electrode connected to the third node N3, and a second electrode connected to a node connected to a first electrode of the sixth control transistor T13 and a gate electrode of the fifth control transistor T12. The fourth control transistor T11 may be turned on based on an electric potential of the Q1 node Q1 and may transfer an electric potential of the third node N3 to the first electrode of the sixth control transistor T13 and the gate electrode of the fifth control transistor T12.

The second capacitor CC may include a first connected to the low voltage line VEL and the third node N3 and a second electrode connected to the Q1 node Q1. The second capacitor CC may allow an electric potential of the Q1 node Q1 to be stably maintained.

The fifth control transistor T12 may include the gate electrode connected to a node connected to the first electrode of the sixth control transistor T13 and the second electrode of the fourth control transistor T11, a first electrode connected to the first node N1 or the first carry signal output terminal CRY, and a second electrode connected to an emission control signal output terminal EMO. The fifth control transistor T12 may be turned on based on an electric potential of the node connected to the first electrode of the sixth control transistor T13 and the second electrode of the fourth control transistor T11 and may output the first carry signal Cry1, transferred through the carry signal output terminal CRY, as a first emission control signal Emo1. The fifth control transistor T12 may output the first emission control signal Emo1 of a high voltage through the emission control signal output terminal EMO, and thus, may be defined as a high voltage emission control signal output transistor.

The sixth control transistor T13 may include a gate electrode connected to the Q1 node Q1, the first electrode connected to the fifth node N5 and the high voltage line VEH, and a second electrode connected to a seventh node N7 connected to the second electrode of the fourth control transistor T11 and the gate electrode of the fifth control transistor T12. The sixth transistor T13 may be turned on based on an electric potential of the Q1 node Q1 and may transfer a high voltage, applied through the high voltage line VEH, to the seventh node N7 connected to the second electrode of the fourth control transistor T11 and the gate electrode of the fifth control transistor T12.

The seventh control transistor T14 may include a gate electrode connected to the Q1 node Q1, a first electrode connected to the low voltage line VEL and the third node N3, and a second electrode connected to the sixth node N6 and the emission control signal output terminal EMO. The seventh control transistor T14 may be turned on based on an electric potential of the Q1 node Q1 and may output a low voltage, applied through the low voltage line VEL, as the first emission control signal Emo1. The seventh control transistor T14 may output the first emission control signal Emo1 of a low voltage through the emission control signal output terminal EMO, and thus, may be defined as a low voltage emission control signal output transistor.

As illustrated in FIGS. 11 and 12, the first signal generator CA(1) may operate based on the start signal Vst and the first clock signal Clk1 and may generate an output signal Out corresponding to the first carry signal. The second clock signal Clk2 may correspond to the clock signal needed for driving of the second signal generator CA(2), and thus, its description may be omitted or may be provided briefly.

In response to a falling edge at which a high voltage is shifted to a low voltage in the first clock signal Clk1 where a high voltage and a low voltage are repeated, the first signal generator CA(1) may generate a high voltage of the output signal Out, based on a high voltage of the start signal Vst, and may generate a low voltage of the output signal Out, based on a low voltage of the start signal Vst. This may be confirmed with reference to a third period 3 and a fourth period 4 where the start signal Vst of a high voltage is applied and a fourth period 4 and a fifth period 5 where the output signal Out of a high voltage is generated. Also, a circuit which generates an output through a method such as the first signal generator CA(1) may be referred to as an edge trigger.

As illustrated in FIGS. 12 and 13, a start signal Vst of a low voltage L and a first clock signal Clk1 of a low voltage L may be applied during the first period 1. The first signal transistor T1, the second signal transistor T2, the fourth signal transistor T4, the fifth signal transistor Tbv, and the sixth signal transistor T6 may be turned on during the first period 1. On the other hand, the third signal transistor T3 and the seventh signal transistor T7 may be turned off during the first period 1. The sixth signal transistor T6 may be turned on during the first period 1, and thus, an output signal Out of a low voltage L may be output through an output terminal OUT.

As illustrated in FIGS. 12 and 14, the start signal Vst of a low voltage L and the first clock signal Clk1 of a high voltage H may be applied during the second period 2. The second signal transistor T2, the fourth signal transistor T4, the fifth signal transistor Tbv, and the sixth signal transistor T6 may be turned on during the second period 2. On the other hand, the first signal transistor T1, the third signal transistor T3, and the seventh signal transistor T7 may be turned off during the second period 2. The turn-on of the sixth signal transistor T6 may be maintained during the second period 2, and thus, the output signal Out of a low voltage L may be output through the output terminal OUT.

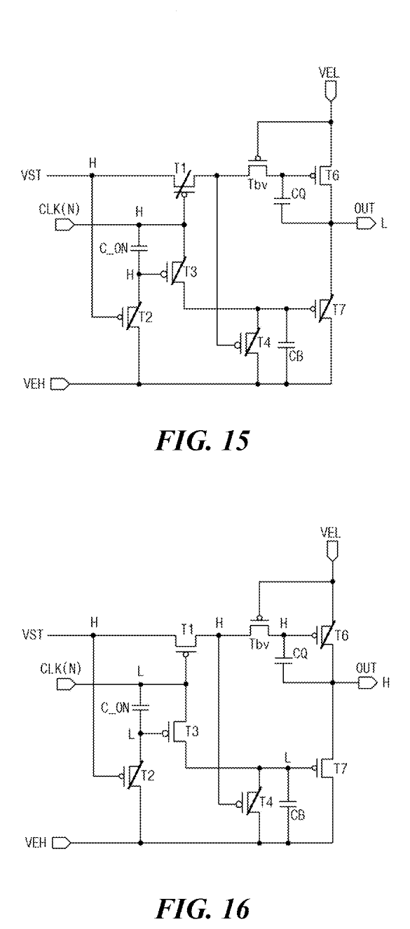

As illustrated in FIGS. 12 and 15, the start signal Vst of a high voltage H and the first clock signal Clk1 of a high voltage H may be applied during the third period 3. The fifth signal transistor Tbs and the sixth signal transistor T6 may be turned on during the third period 3. On the other hand, the first signal transistor T1, the second signal transistor T2, the third signal transistor T3, the fourth signal transistor T4, and the seventh signal transistor T7 may be turned off during the third period 3. The turn-on of the sixth signal transistor T6 may be maintained during the third period 3, and thus, the output signal Out of a low voltage L may be output through the output terminal OUT.

As illustrated in FIGS. 12 and 16, the start signal Vst of a high voltage H and the first clock signal Clk1 of a low voltage L may be applied during the fourth period 4. The fifth signal transistor Tbv, the first signal transistor T1, the third signal transistor T3, and the seventh signal transistor T7 may be turned on during the fourth period 4. On the other hand, the second signal transistor T2, the fourth signal transistor T4, and the sixth signal transistor T6 may be turned off during the fourth period 4. The seventh signal transistor T7 may be turned on during the fourth period 4, and thus, the output signal Out of a high voltage H may be output through the output terminal OUT.

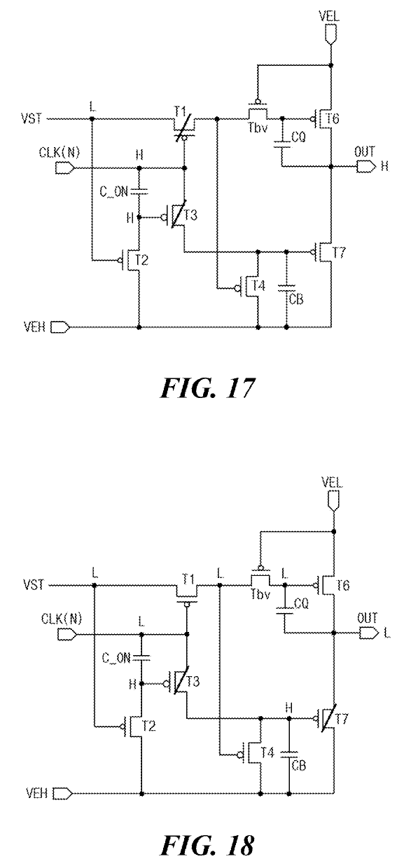

As illustrated in FIGS. 12 and 17, the start signal Vst of a low voltage L and the first clock signal Clk1 of a high voltage H may be applied during the fifth period 5. The second signal transistor T2, the fifth signal transistor Tbs, and the seventh signal transistor T7 may be turned on during the fifth period 5. On the other hand, the first signal transistor T1, the third signal transistor T3, the fourth signal transistor T4, and the sixth signal transistor T6 may be turned off during the fifth period 5. The turn-on of the seventh signal transistor T7 may be maintained during the fifth period 5, and thus, the output signal Out of a high voltage H may be output through the output terminal OUT.

As illustrated in FIGS. 12 and 18, the start signal Vst of a low voltage L and the first clock signal Clk1 of a low voltage L may be applied during the sixth period 6. The first signal transistor T1, the second signal transistor T2, the fourth signal transistor T4, the fifth signal transistor Tbv, and the sixth signal transistor T6 may be turned on during the sixth period 6. On the other hand, the third signal transistor T3 and the seventh signal transistor T7 may be turned off during the sixth period 6. The sixth signal transistor T6 may be turned on during the sixth period 6, and thus, the output signal Out of a low voltage L may be output through the output terminal OUT.

Hereinafter, an operation of the first signal controller CT(1) will be described based on an output of the first signal generator CA(1), the first control signal applied through the first control signal input terminal ENB, and the second control signal applied through the second control signal input terminal EN.

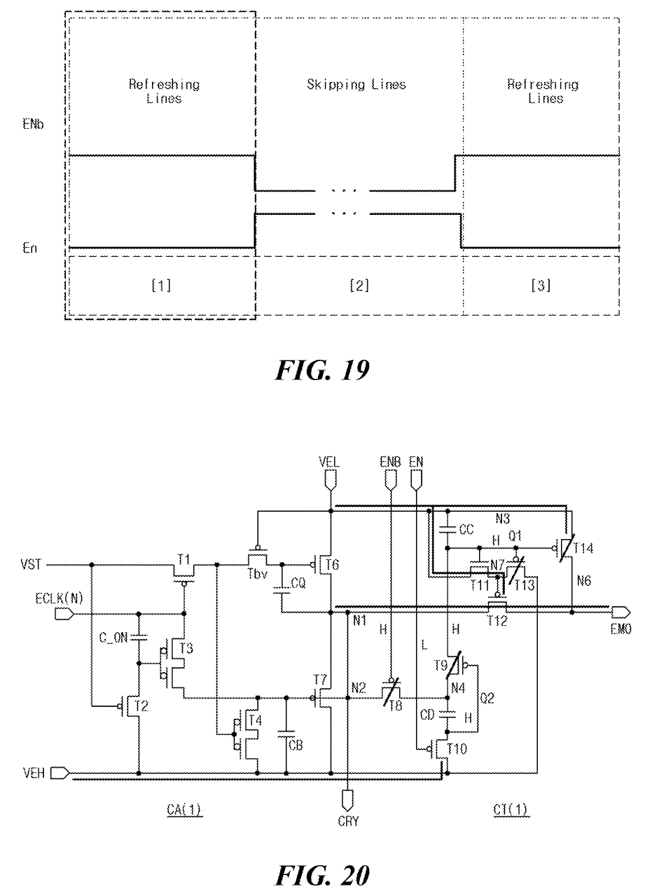

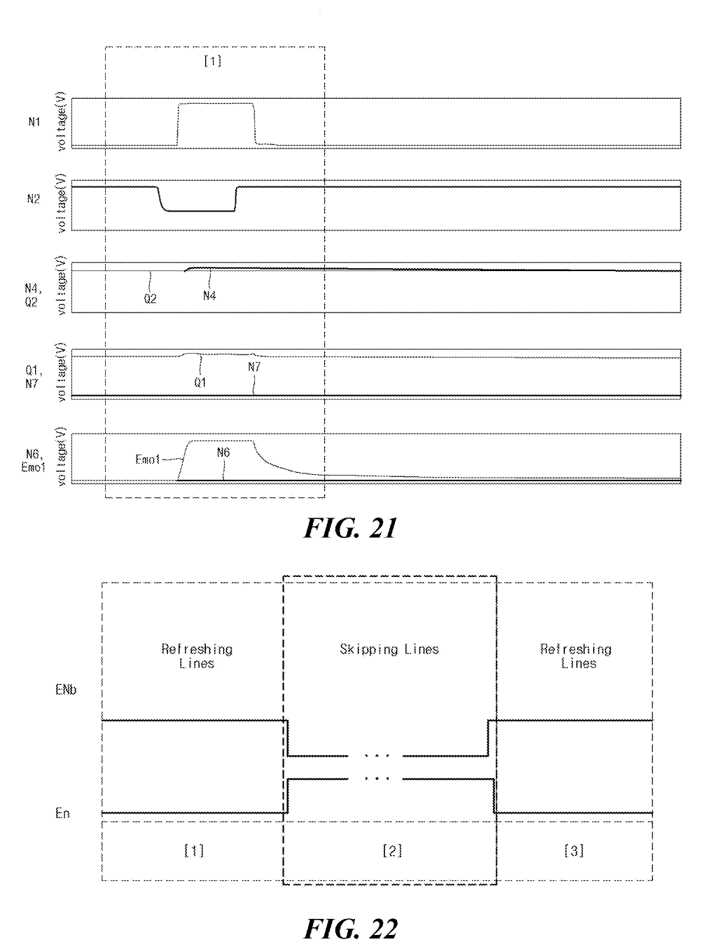

FIG. 19 is a waveform diagram illustrating a first control signal and a second control signal applied during a first period, FIG. 20 is a state diagram illustrating an operation performed by a first signal controller during the first period, and FIG. 21 is a waveform diagram illustrating a node voltage and an output of the first signal controller during the first period.

As illustrated in FIGS. 19, 20, and FIG. 21, during a first period 1, a first control signal ENb of a high voltage H may be applied through a first control signal input terminal ENB, and a second control signal En of a low voltage L may be applied through a second control signal input terminal EN. The first period 1 and a third period 3 may each be defined as a period for controlling refreshing lines included in a refresh fame. Hereinafter, an operation and an output each performed by a first signal controller CT(1) will be described with respect to the first period 1.

During the first period 1, a first node N1, a fourth node N4, a Q1 node Q1, a seventh node N7, and a Q2 node Q2 may have an electrical potential of a high voltage H, and a second node N2 and a sixth node N6 may have an electrical potential of a low voltage L.

A third control transistor T10, a fourth control transistor T11, and a fifth control transistor T12 may be turned on during the first period 1. On the other hand, a first control transistor T8, a second control transistor T9, a sixth control transistor T13, and a seventh control transistor T14 may be turned off. The fifth control transistor T12 may be turned on, and thus, an electric potential of a high voltage H of the first node N1 may be output as an emission control signal Emo1 of a high voltage through an emission control signal output terminal EMO.

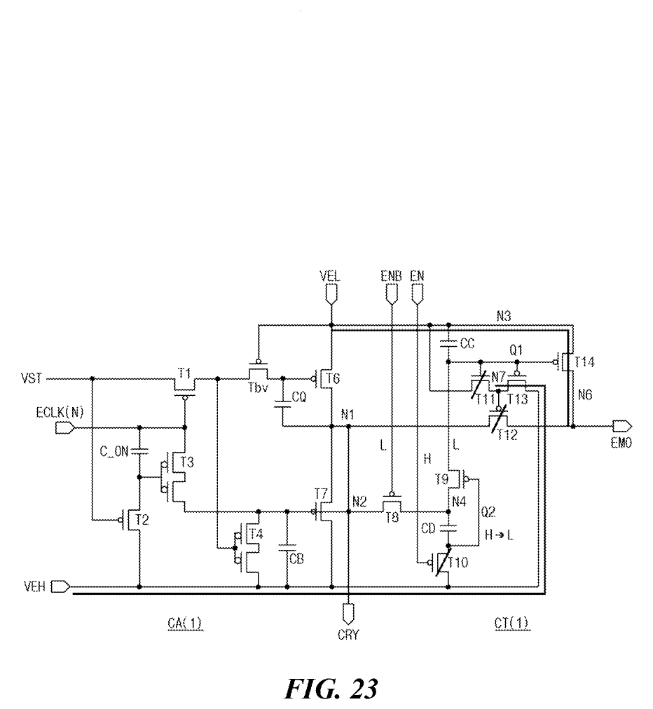

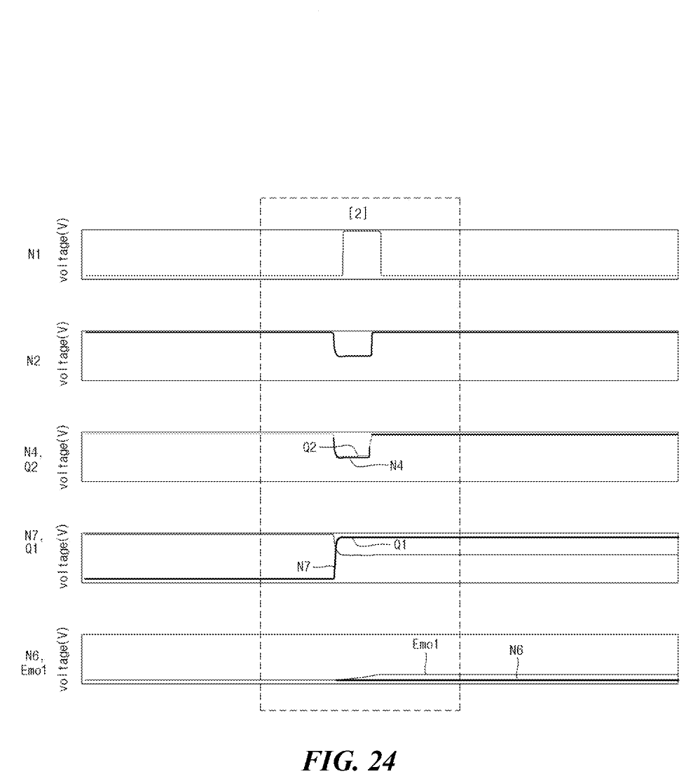

FIG. 22 is a waveform diagram illustrating a first control signal and a second control signal applied during a second period, FIG. 23 is a state diagram illustrating an operation performed by a first signal controller during the second period, and FIG. 24 is a waveform diagram illustrating a node voltage and an output of the first signal controller during the second period.

As illustrated in FIGS. 22, 23, and 24, during a second period 2, a first control signal ENb of a low voltage L may be applied through a first control signal input terminal ENB, and a second control signal En of a high voltage H may be applied through a second control signal input terminal EN. The second period 2 may be defined as a period for controlling skipping lines included in frame skip.

During the second period 2, a first node N1 and a seventh node N7 may have an electrical potential of a high voltage H, and a second node N2, a fourth node N4, a Q1 node Q1, a Q2 node Q2, and a sixth node N6 may have an electrical potential of a low voltage L.

A sixth control transistor T13 and a seventh control transistor T14 may be turned on during the second period 2. On the other hand, a first control transistor T8, a second control transistor T9, a third control transistor T10, a fourth control transistor T11, and a fifth control transistor T11 may be turned off. The seventh control transistor T14 may be turned on, and thus, an electric potential of a low voltage L of the third node N3 may be output as an emission control signal Emo1 of a low voltage through an emission control signal output terminal EMO.

Furthermore, in FIGS. 19 and 22, an example is illustrated where the first control signal ENb and the second control signal En may be applied in opposite forms during a first period 1 and a third period 3 and may be applied in opposite forms during the second period 2, and a period of holding a high voltage may be identically provided during a transition period which occurs while entering the third period 3. However, this may be merely an embodiment, and the first control signal ENb and the second control signal En may be applied in opposite forms during the first to third periods 1 to 3.

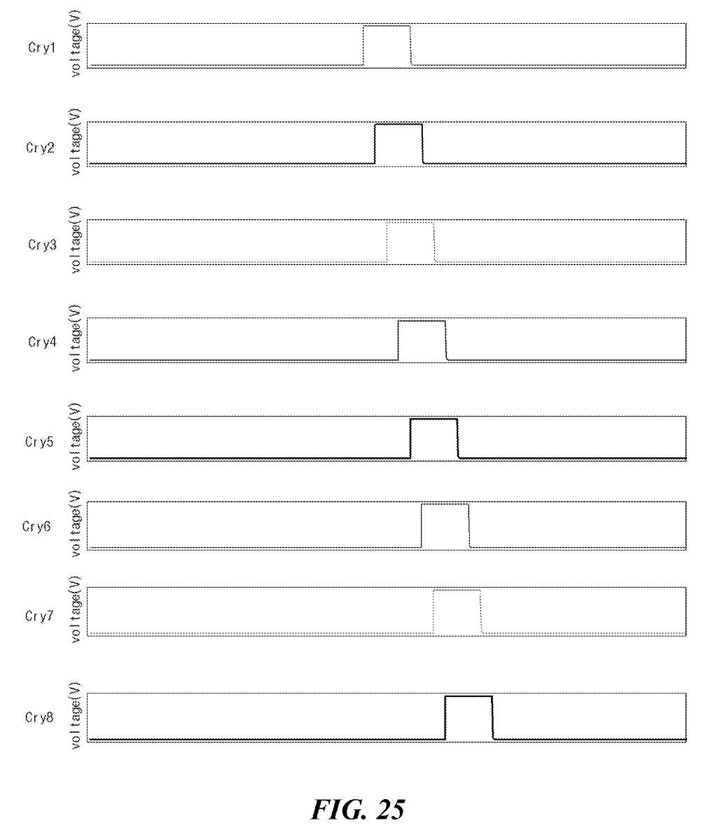

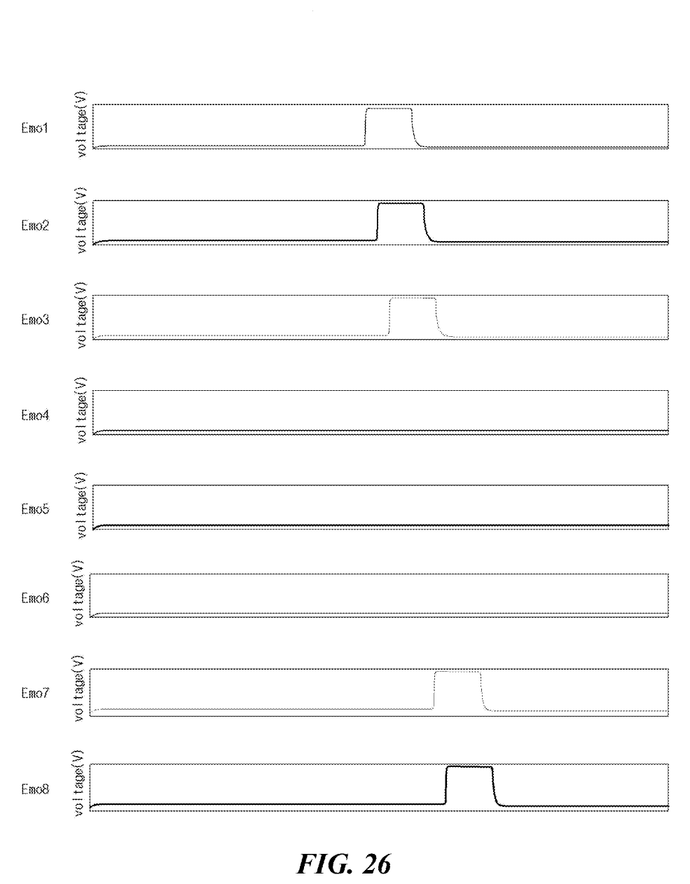

FIG. 25 is an output waveform diagram of carry signals output from signal generators of FIG. 10, and FIG. 26 is an output waveform diagram of emission control signals output from signal controllers of FIG. 10. In FIG. 10, only a total of four signal generators and four signal controllers are illustrated, but in FIGS. 25 and 26, in order to show an output characteristic of emission control signals according to frame skip, a total of eight carry signals and eight emission control signals are additionally illustrated and described.

As illustrated in FIGS. 10 and 25, the signal generators CA(1) to CA(4) included in the emission control signal driver CA and CT may operate based on a start signal or a clock signal and a carry signal of a signal generator included in a front-end stage and may output carry signals Cry1 to Cry8 in a form where some periods overlap each other.

As illustrated in FIGS. 10 and 26, the signal controllers CT(1) to CT(4) included in the emission control signal driver CA and CT may operate based on carry signals and control signals output from the signal generators CA(1) to CA(4) and may output emission control signals Emo1 to Emo8 in a form where some periods overlap each other.

In the embodiments, an example is illustrated and has been described where carry signals are generated so that some periods thereof overlap each other, and emission control signals are output so that some periods thereof overlap each other. However, the carry signals and the emission control signals may be generated and output in a non-overlap form.

Furthermore, as seen in FIGS. 22 to 24, the signal controllers CT(1) to CT(4) included in the emission control signal driver CA and CT may perform a frame skip operation, based on at least two control signals ENb and En. When the frame skip operation is performed, an emission control signal may be output in the form of low voltage instead of a high voltage as in fourth to sixth emission control signals Emo4 to Emo6 of FIG. 26.

Referring to the above descriptions, the signal controller CT may intactly output, as an emission control signal, a carry signal output from the signal generator CA in response to at least two control signals ENb and En, or may change (convert) an electrical potential of the carry signal to output as the emission control signal. At this time, a high voltage generating time and a low voltage generating time of the emission control signal may vary based on the high voltage generating time and the low voltage generating time configuring the at least two control signals ENb and En. To provide an additional description, the signal controller CT may vary (change) an operating condition to correspond to a variation of a driving frequency, based on the control of an output waveform of the emission control signal.

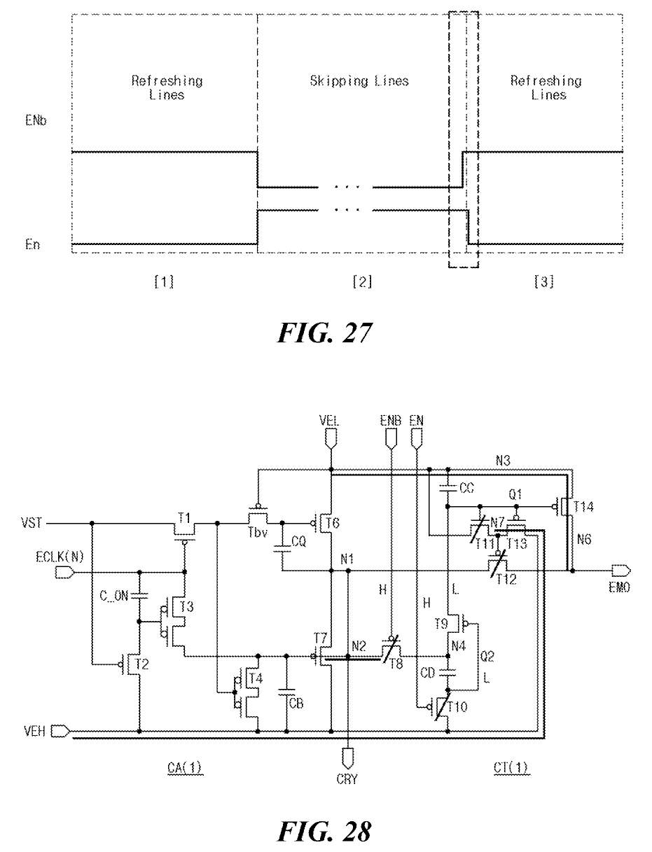

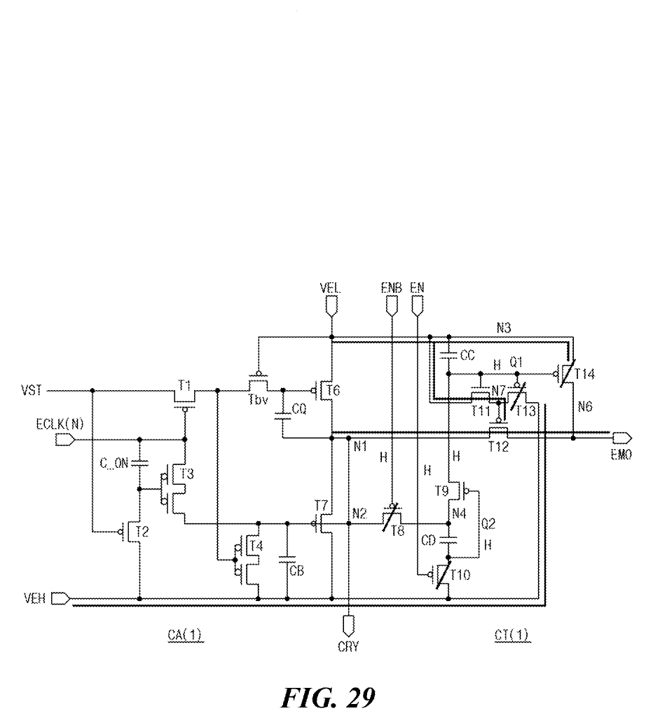

FIG. 27 is a waveform diagram illustrating a portion where a first control signal and a second control signal maintain a high voltage, and FIGS. 28 and 29 are state diagrams illustrating an operation performed by a first signal controller, based on a waveform illustrated in FIG. 27.

As illustrated in FIG. 27, a first control signal ENb and a second control signal En may have a high voltage overlap period where certain time high voltages overlap each other between a second period 2 and a third period 3. That is, a transition period based on changing of a driving mode may be provided between the second period 2 and the third period 3.

A last signal controller CT(n) performing frame skip as illustrated in FIG. 28 and a first signal controller CT(1) performing a refresh frame as illustrated in FIG. 29 may have a high voltage overlap period where a second node N2 and a QB node QB have a high voltage overlap period having an electric potential of a high voltage, between the second period 2 and the third period 3.

As in FIG. 28, in the last signal controller CT(n), even when a first control signal ENb and a second control signal En are applied to be a high voltage H, and the second node N2 and the QB node QB have an electric potential of a high voltage, an electric potential of each of a fourth node N4 and a Q2 node Q2 may have a low voltage L. Therefore, even when a sixth control transistor T13 is turned on based on an electric potential of a Q1 node Q1, a fifth control transistor T12 may be turned off, and a seventh control transistor T14 may be turned on based on the electric potential of the Q1 node Q1. Accordingly, subpixels connected to a last gate line may perform frame skip, based on an emission control signal of a low voltage L output from the last signal controller CT(n).

As in FIG. 29, in the first signal controller CT(1), even when the first control signal ENb and the second control signal En are applied to as a high voltage H, and the second node N2 and the QB node QB have an electric potential of a high voltage, an electric potential of each of a first node N1 and the Q2 node Q2 may have a high voltage H. Therefore, a fourth control transistor T11 may be turned on based on the electric potential of the Q1 node Q1, and the fifth control transistor T12 may be turned on based on the electric potential of the third node N3. Accordingly, subpixels connected to a first gate line may perform a refresh frame, based on an emission control signal of a high voltage H output from the first signal controller CT(1).

As described above, the signal controllers CT(1) and CT(n) may include transistors T8 and 10 which may separate and control an electric potential of a node even when a transition period occurs between the second period 2 and the third period 3, and thus, relatively stabilized mode change may be performed between frame skip driving and refresh frame driving.

Hereinabove, the present disclosure provides a gate driver and a display apparatus including the same, which may output a signal for diversifying a region-based driving frequency to convert into a multi-frequency, when displaying at least two images on a display panel. Also, the present disclosure provides a gate driver and a display apparatus including the same, which may freely change an output waveform by using a relatively simple circuit and a signal, when diversifying a driving frequency for each display area. Also, the present disclosure provides a gate driver and a display apparatus including the same, which may easily and stably change refresh frame driving and frame skip driving, based on a relatively simple circuit and a signal.

The effects according to the present disclosure are not limited to the above examples, and other various effects may be included in the specification.

While the present disclosure has been particularly shown and described with reference to exemplary embodiments thereof, it will be understood by those of ordinary skill in the art that various changes in form and details may be made therein without departing from the technical idea and scope of the present disclosure including those of the following claims.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a display panel configured to display an image; and
a gate driver including a scan signal driver configured to apply at least one scan signal to the display panel, and an emission control signal driver configured to apply an emission control signal to the display panel,
wherein the emission control signal driver comprises:
a signal generator configured to generate a carry signal; and
a signal controller configured to output the carry signal generated by the signal generator as the emission control signal or vary an electric potential of the carry signal to output the carry signal with varied electrical potential as the emission control signal, based on at least two control signals.

2. The display apparatus of claim 1, wherein the signal controller is configured to receive an electric potential of each of a first node and a second node of the signal generator as an input.

3. The display apparatus of claim 1, wherein the signal controller is configured to output the carry signal as a high voltage, based on a high voltage generated in a first node of the signal generator, or
the signal controller is configured to vary the carry signal to a low voltage to output the carry signal having the low voltage, based on a low voltage applied to the signal controller.

4. The display apparatus of claim 2, wherein the signal controller comprises:
a first control transistor including a gate electrode connected to a first control signal input terminal to which a first control signal is applied and a first electrode connected to the second node;
a second control transistor including a gate electrode connected to a Q2 node, a first electrode connected to a Q1 node, and a second electrode connected to a fourth node defined by a second electrode of the first control transistor;
a third control transistor including a gate electrode connected to a second control signal input terminal to which a second control signal is applied, a first electrode connected to a high voltage line to which a high voltage is applied, and a second electrode connected to the Q2 node;
a fourth control transistor including a gate electrode connected to the Q1 node and a first electrode connected to a third node defined by a low voltage line to which a low voltage is applied;
a fifth control transistor including a gate electrode connected to a second electrode of the fourth control transistor, a first electrode connected to the first node, and a second electrode connected to an emission control signal output terminal;
a sixth control transistor including a gate electrode connected to the Q1 node, a first electrode connected to a fifth node defined by the high voltage line, and a second electrode connected to a seventh node connected to the second electrode of the fourth control transistor and the gate electrode of the fifth control transistor; and
a seventh control transistor including a gate electrode connected to the Q1 node, a first electrode connected to the third node, and a second electrode connected to the emission control signal output terminal.

5. The display apparatus of claim 4, wherein the signal controller comprises:
a first capacitor including a first electrode connected to the fourth node and a second electrode connected to the Q2 node; and
a second capacitor including a first electrode connected to the third node and a second electrode connected to the Q1 node.

6. The display apparatus of claim 4, wherein the first control signal and the second control signal are applied in opposite forms.

7. The display apparatus of claim 4, wherein, in response to the first control signal is applied as a high voltage, and the second control signal is applied as a low voltage, the signal controller is configured to output the carry signal as a high voltage, and
in response to the first control signal is applied as a low voltage, and the second control signal is applied as a high voltage, the signal controller is configured to vary the carry signal to a high voltage and to output the carry signal having the high voltage.

8. A gate driver comprising:
a scan signal driver configured to output at least one scan signal; and
an emission control signal driver configured to apply an emission control signal,
wherein the emission control signal driver comprises:
a signal generator configured to generate a carry signal; and
a signal controller configured to output the carry signal generated by the signal generator as the emission control signal or vary an electric potential of the carry signal to output the carry signal with varied electrical potential as the emission control signal, based on at least two control signals.

9. The gate driver of claim 8, wherein the signal controller is supplied with an electric potential of each of a first node and a second node of the signal generator as an input.

10. The gate driver of claim 9, wherein the signal controller comprises:
a first control transistor including a gate electrode connected to a first control signal input terminal to which a first control signal is applied and a first electrode connected to the second node;
a second control transistor including a gate electrode connected to a Q2 node, a first electrode connected to a Q1 node, and a second electrode connected to a fourth node defined by a second electrode of the first control transistor;
a third control transistor including a gate electrode connected to a second control signal input terminal to which a second control signal is applied, a first electrode connected to a high voltage line to which a high voltage is applied, and a second electrode connected to the Q2 node;
a fourth control transistor including a gate electrode connected to the Q1 node and a first electrode connected to a third node defined by a low voltage line to which a low voltage is applied;
a fifth control transistor including a gate electrode connected to a second electrode of the fourth control transistor, a first electrode connected to the first node, and a second electrode connected to an emission control signal output terminal;
a sixth control transistor including a gate electrode connected to the Q1 node, a first electrode connected to a fifth node defined by the high voltage line, and a second electrode connected to a seventh node connected to the second electrode of the fourth control transistor and the gate electrode of the fifth control transistor; and
a seventh control transistor including a gate electrode connected to the Q1 node, a first electrode connected to the third node, and a second electrode connected to the emission control signal output terminal.
